(19) United States
(12) Patent Application Publication
(10) Pub. No.: US 2020/0099829 A1
(43) Pub. Date: Mar. 26, 2020

(54) Portable Device Accessory

(71) Applicant: Ryan Carson Lewis, Houston, TX (US)

(72) Inventor: Ryan Carson Lewis, Houston, TX (US)

(21) Appl. No.: 16/582,984

(22) Filed: Sep. 25, 2019

Related U.S. Application Data
(60) Provisional application No. 62/735,956, filed on Sep. 25, 2018.

(51) Int. Cl. H04N 5/225; H04M 1/04; A45F 5/10

(52) U.S. Cl. CPC H04N 5/2253; G06F 1/1626; A45F 5/10; H04M 1/04

(57) ABSTRACT

The present invention is a portable device accessory that includes a cover, a plurality of hooks, a connector, an adhesive pad, a plurality of protrusions, and a plurality of attachment bodies. The adhesive pad is attached to one side of the connector. The other side of the connector is attached to a portable device or other accessories by the plurality of attachment bodies. The user may remove the cover to reveal the adhesive pad, then temporary attaches the adhesive pad to other surfaces so the user may take a selfie with the portable device. After the user detaches the adhesive pad, the user may place the cover over the adhesive pad, then turn the cover so the plurality of hooks on the cover engages and locks to the plurality of protrusions on the connector.

The current application claims a priority to the U.S. Provisional Patent application Ser. No. 62/735,956 filed on Sep. 25, 2018.

### FIELD OF THE INVENTION

The present invention generally relates to an incrementally-sizeable grip/stand accessory known as popsocket. More specifically, the present invention is an accessory attachment for popsocket so that the user may mount a portable device to different surfaces or position the portable device to perform different functions like taking picture or video.

### BACKGROUND OF THE INVENTION

Portable devices such as cellular phone or tablet are carried by most people on daily, or even hourly basis because they are very convenient to carry around and powerful enough for the users to complete many tasks. Most people cannot even leave home without carrying a portable device, due to massive amounts of social network interactions accessible from portable devices. For example, many users take a selfie car other pictures to post on Facebook, Instagram, twitter, or other websites with portable devices. However, issues arise because most portable devices do not have any attaching mechanism to enable to user to attach the portable device to another surface. While selfie stick does exist, this issue remained unsolved, because the selfie stick cannot cover all the different angles, and has limited flexibility, since the user must use one hand to hold the selfie stick, and the selfie stick only extends to a certain length.

The present invention provides a solution to all abovementioned issues by providing a portable device accessory, which allow the user to quickly attach and detach the portable device to various surfaces. The present invention can be attached to an accessory on the portable device known as popsocket. Then, the user may attach the present invention with the portable device to various surfaces to take a picture, a video clip, or just perform other functions such as playing music or video. The present invention is both small and flexible, so it does not occupy too much space when attaching to the portable device. Moreover, the present invention is flexible enough to attach to different portable devices or accessories to expand the functions of portable devices. This invention strives to be a universal mount for our portable devices to enable us to use have full use of these devices hands-free wherever we go.

### BRIEF DESCRIPTION OF THE DRAWINGS

FIG. 1 is a perspective exploded view of the present invention.

FIG. 2 is a bottom perspective exploded view of the present invention.

FIG. 3 is a bottom perspective view of the cover.

FIG. 4 is a side view of the cover.

FIG. 5 is a perspective view of the connector with the adhesive pad.

FIG. 6 is a bottom perspective view of the connector.

FIG. 7 is a top view of the cover, showing the plane upon which a cross section view is taken shown in FIG. 8.

FIG. 8 is a cross section view of the present invention taken along line 8-8 of FIG. 7.

### DETAIL DESCRIPTIONS OF THE INVENTION

All illustrations of the drawings are for the purpose of describing selected versions of the present invention and are not intended to limit the scope of the present invention.

The present invention is a portable device accessory that allows the user to temporary attaches the portable device such as mobile phones or tables to different surfaces to take pictures or videos. More specifically, the present invention can be attached to an incrementally-sizeable grip/stand accessory, also known as popsocket, on the portable device.

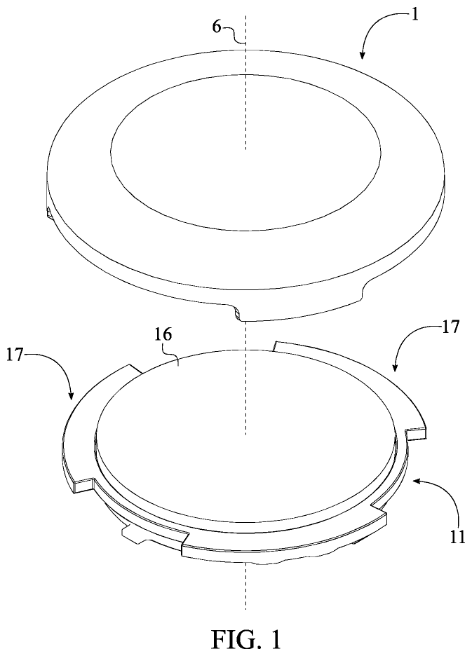

In reference to FIGS. 1, 2, and 6, the present invention comprises a cover 1, a plurality of hooks 7, a connector 11, an adhesive pad 16, a plurality of protrusions 17, and a plurality of attachment bodies 21. The cover 1 is configured to prevent dust or other objects from contacting the adhesive pad 16. The plurality of hooks 7 is radially distributed on the cover 1. The plurality of hooks 7 is configured to attach the cover 1 to the connector 11 when the user wishes to cover the adhesive pad 16. The plurality of protrusions 17 is a type of locking mechanism that is configured to allow the user to engage the plurality of hooks 7 to the plurality of protrusions 17 and lock/attach the cover 1 onto the connector 11 thus enclosing the entire adhesive pad 16. The plurality of protrusions 17 is externally connected to the connector 11. This configuration allows the cover 1 to encircle around the connector 11. The plurality of protrusions 17 is also radially distributed around the connector 11. This configuration allows the user to encloses the adhesive pad 16 evenly and prevents the cover 1 from falling off from the connector 11 by accident or other impacts.

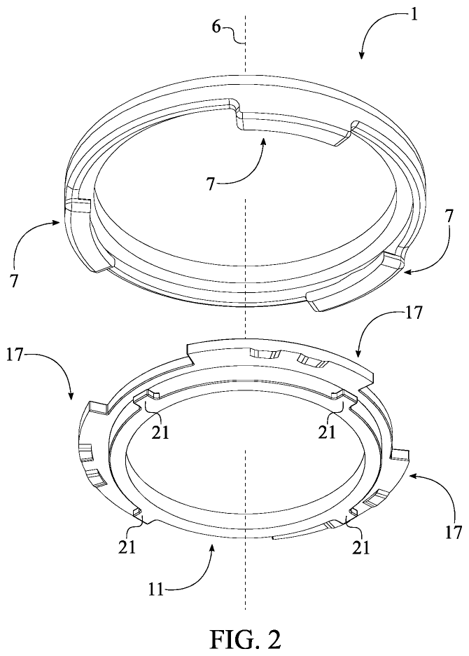

In reference to FIGS. 1 and 2, the plurality of attachment bodies 21 is configured to attach the present invention to the incrementally-sizeable grip/stand accessory, also known as the popsocket. The plurality of attachment bodies 21 is radially distributed around the connector 11 to ensure the connector 11 is evenly attached to popsocket or a different surface and to prevent the connector 11 from falling off. The plurality of attachment bodies 21 is externally connected to the connector 11. This configuration is to ensure the connector 11 is internally attached to the popsocket or a different surface. The plurality of protrusions 17 and the plurality of attachment bodies 21 being oppositely positioned with each other about the connector 11. The adhesive pad 16 is positioned between the cover 1 and the connector 11. The adhesive pad 16 is terminally connected to the connector 11. The adhesive pad 16 is configured to allow the user to temporary attach the connector 11 to another surface.

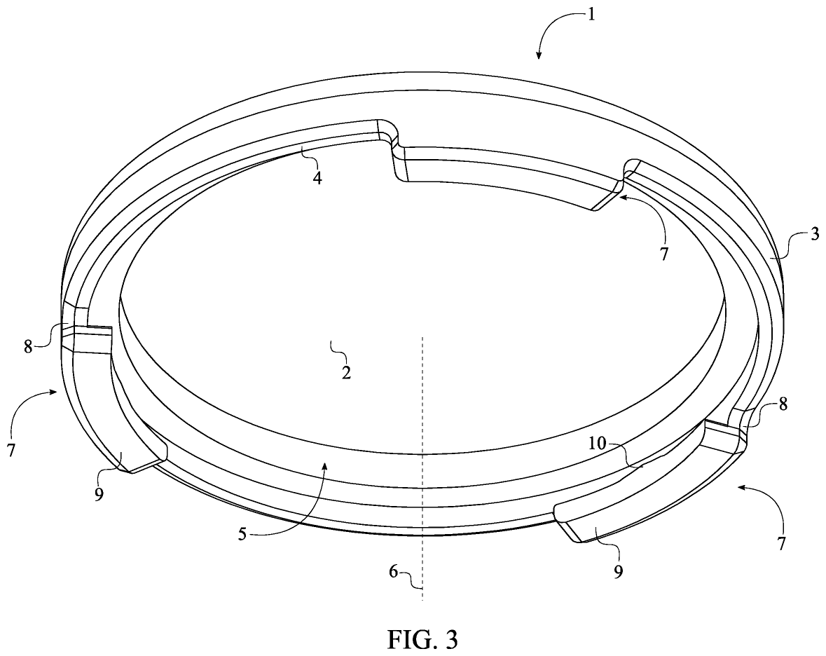

In reference to FIGS. 1 and 3, the cover 1 comprises a first base 2, an annular flange 3, a first edge 4, a first opening 5, and a central axis 6. The first base 2 is configured to cover the entire adhesive pad 16 and also functions as a foundation to hold other components of the cover 1. The annular flange 3 is concentrically positioned to the first base 2 along the central axis 6. The annular flange 3 is configured to surround the side of the adhesive pad 16 and preventing dust or other items from contacting the adhesive pad 16 from the side. The first opening 5 being delineated by the annular flange 3 and the first base 2. The first opening 5 is configured to receive the adhesive pad 16. The first edge 4 is concentrically positioned around the central axis 6. The first edge 4 and the first base 2 are oppositely positioned of each other about the annular flange 3. The first edge 4 is configured to press against the outer edge of the connector 11 to prevent dust or other unwanted objects from contacting the adhesive pad 16.

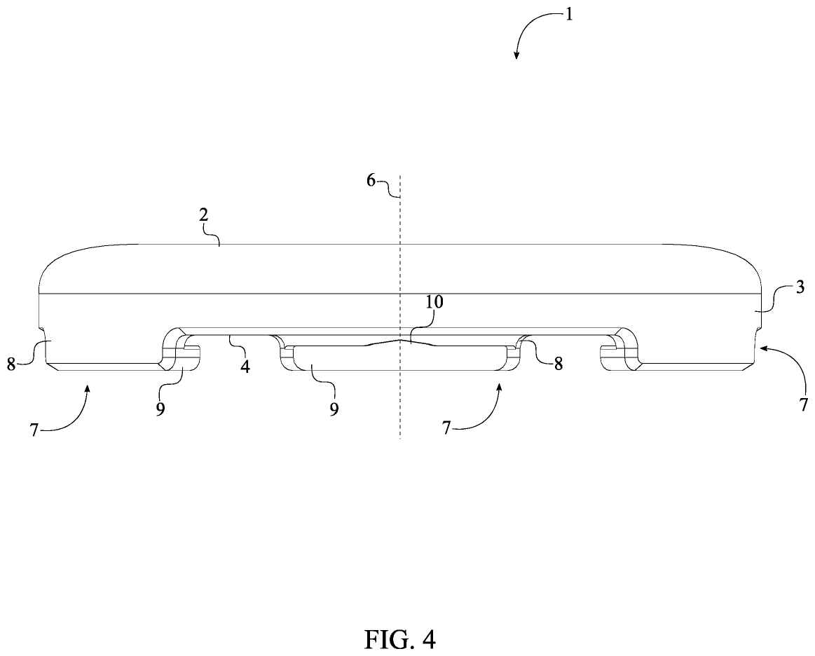

In reference to FIG. 3-6, each of the plurality of hooks 7 comprises a first leg 8, a second leg 9, and at least one first protrusion 10. The first leg 8 is perimetrically connected along the first edge 4. The first leg 8 is configured to extend the plurality of hooks 7 and allows the plurality of hooks 7 to properly engage with the plurality of protrusions 17. The second leg 9 is angularly connected to the first leg 8. The second leg 9 is oriented toward the first opening 5. In other words, the second leg 9 is extending toward the center of the cover 1. Since the cover 1 is designed to be slightly larger than the connector 11 to cover the entire adhesive pad 16, the second leg 9 extends toward the center of the cover 1 to engage the plurality of protrusions 17. The at least one first protrusion 10 is connected onto the second leg 9 so the second leg 9 may engage with the corresponding plurality of protrusions 17. The at least one first protrusion 10 is oriented toward the first base 2. The at least one first protrusion 10 is configured to directly engage with the corresponding plurality of protrusions 17 and lock the cover 1 to the connector 11.

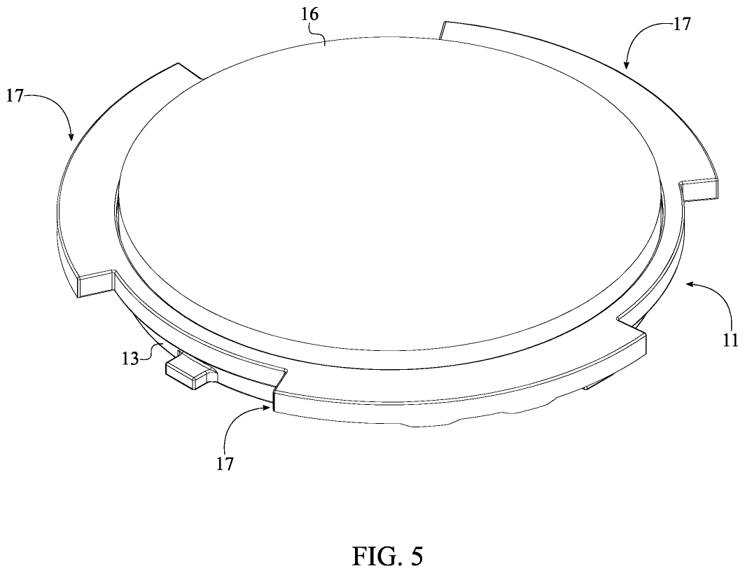

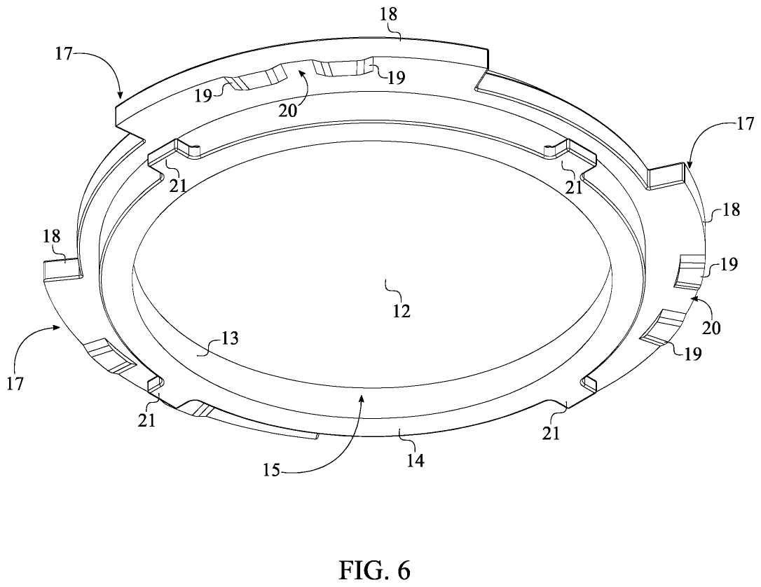

In reference to FIGS. 5 and 6, the connector 11 comprises a second base 12, a lateral wall 13, a second edge 14, and a second opening 15. The connector 11 is configured to install the adhesive pad 16 to the portable device or other relevant accessories. The second base 12 is configured as the base to hold or connect to all other components of the connector 11. The lateral wall 13 is concentrically connected around the second base 12. The lateral wall 13 is configured to attach the connector 11 to portable devices or other accessories. The second edge 14 is concentrically positioned on the lateral wall 13, opposite of the second base 12. The second edge 14 is configured to serve as the direct contact point between the connector 11 and the portable device. The second opening 15 is delineated by the lateral wall 13 and the second base 12. The second opening 15 is configured to allow the user to install the present invention to certain accessories, such as the popsocket. The user may introduce the top portion of the popsocket around the second opening 15. The adhesive pad 16 is connected onto the second base 12. The adhesive pad 16 and the lateral wall 13 are oppositely positioned of each other about the second base 12. The user may remove the cover 1 to reveal the adhesive pad 16, then temporary attaches the adhesive pad 16 to another surface so the connector 11 also attaches to the same surface along with the portable device.

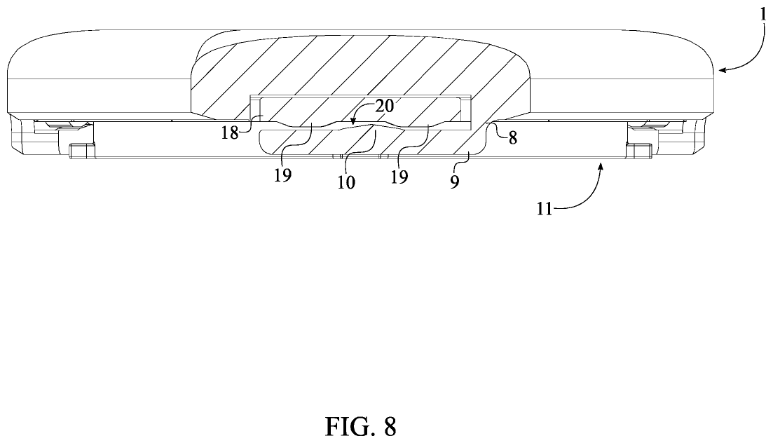

In reference to FIGS. 6 and 8, each of the plurality of protrusions 17 comprises a structural body 18, a plurality of second protrusions 19, and at least one locking divot 20. The structural body 18 is configured as a base to hold the plurality of second protrusions 19 and at least one locking divot 20. The structural body 18 is externally connected around the lateral wall 13 to keep the space inside of the lateral wall 13 unoccupied. The structural body 18 is positioned adjacent to the second base 12. The structural body 18 is radially distributed around the second base 12 to ensure the plurality of hooks 7 of the cover 1 engages the plurality of protrusions 17 evenly so the adhesive pad 16 is covered evenly by the cover 1. The plurality of second protrusions 19 is connected along the structural body 18. The at least one locking divot 20 is positioned between the plurality of second protrusions 19. As the user places the entire cover 1 over the adhesive pad 16, the user may turn the cover 1 so the at least one first protrusion 10 of one of the plurality of hooks 7 engages and locks with the at least one locking divot 20 of the corresponding one plurality of second protrusions 19. The plurality of second protrusions 19 is oriented toward the second edge 14. This configuration ensures the plurality of second protrusions 19 engages with the plurality of first protrusion 10 when the user is covering the adhesive pad 16 with the cover 1.

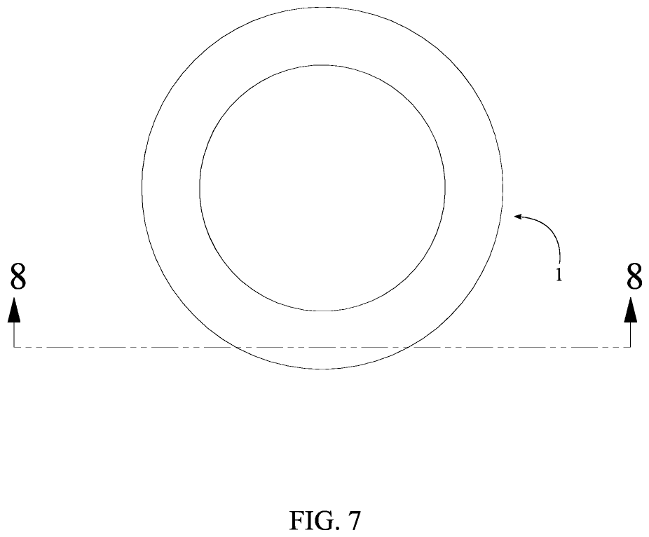

In reference to FIG. 6-8, the plurality of attachment bodies 21 is externally connected around the lateral wall 13. This configuration is to keep the second opening 15 inside the popsocket, other portable devices, or accessories. The plurality of attachment bodies 21 is positioned adjacent to the second edge 14 to provide immediate contacting points when the user attaches the popsocket, other portable devices, or accessories to the connector 11. The plurality of attachment bodies 21 is radially distributed around the second base 12. This configuration is to ensure the plurality of attachment bodies 21 can properly lock with the popsocket, other portable devices, or accessories.

In reference to FIGS. 5 and 8, each of the plurality of hooks 7 comprises the at least one first protrusion 10. Each of the plurality of protrusions 17 comprises the at least one locking divot 20. The at least one locking divot 20 and the at least one first protrusion 10 are engaged with each other. As the user places the cover 1 over the entire adhesive pad 16, the user may turn the cover 1 so each of the plurality of first protrusion 10 engages with the at least one locking divot 20 and locks the cover 1 to the connector 11.

Although the invention has been explained in relation to its preferred embodiment, it is to be understood that many other possible modifications and variations can be made without departing from the spirit and scope of the invention.

What is claimed is:

1. A portable device accessory comprises:
a cover;
a plurality of hooks;
a connector;
an adhesive pad;
a plurality of protrusions;
a plurality of attachment bodies;
the plurality of hooks being radially distributed on the cover;
the plurality of protrusions being externally connected to the connector;
the plurality of protrusions being radially distributed around the connector;
the plurality of attachment bodies being externally connected to the connector;
the plurality of attachment bodies being radially distributed around the connector;
the plurality of protrusions and the plurality of attachment bodies being oppositely positioned with each other about the connector;
the adhesive pad being positioned between the cover and the connector;
the adhesive pad being terminally connected to the connector; and
the connector and the cover being attached to each other by the plurality of hooks and the plurality of protrusions.

2. The portable device accessory as claimed in claim 1 comprises:
the cover comprising a first base, an annular flange, a first edge, a first opening, and a central axis;
the annular flange being concentrically positioned to the first base along the central axis;
the first opening being delineated by the annular flange and the first base;
the first edge being concentrically positioned around the central axis; and
the first edge and the first base being oppositely positioned of each other about the annular flange.

3. The portable device accessory as claimed in claim 1 comprises:
the cover comprising a first base, a first edge and a first opening;
each of the plurality of hooks comprising a first leg, a second leg, and at least one first protrusion;
the first leg being perimetrically connected along the first edge;
the first leg being perpendicularly positioned to the first base;
the second leg being angularly connected to the first leg;
the second leg being oriented toward the first opening;
the at least one first protrusion being connected onto the second leg; and
the at least one first protrusion being oriented toward the first base.

4. The portable device accessory as claimed in claim 1 comprises:
the connector comprising a second base, a lateral wall, a second edge, and a second opening;
the lateral wall being concentrically connected around the second base;
the second edge being concentrically positioned on the lateral wall, opposite of the second base;
the second opening being delineated by the lateral wall and the second base;
the adhesive pad being connected onto the second base; and
the adhesive pad and the lateral wall being oppositely positioned of each other about the second base.

5. The portable device accessory as claimed in claim 1 comprises:
the connector comprising a lateral wall, a second edge, and a second base;
each of the plurality of protrusions comprising a structural body, a plurality of second protrusions, and at least one locking divot;
the structural body being externally connected around the lateral wall;
the structural body being positioned adjacent to the second base;
the structural body being radially distributed around the second base;
the plurality of second protrusions being connected along the structural body;
the at least one locking divot being positioned between the plurality of second protrusions; and
the plurality of second protrusions being oriented toward the second edge.

6. The portable device accessory as claimed in claim 1 comprises:
the connector comprising a lateral wall, a second edge, and a second base;
the plurality of attachment bodies being externally connected around the lateral wall;
the plurality of attachment bodies being positioned adjacent to the second edge; and
the plurality of attachment bodies being radially distributed around the second base.

7. The portable device accessory as claimed in claim 1 comprises:
each of the plurality of hooks comprising at least one first protrusion;
each of the plurality of protrusions comprising at least one locking divot; and
the at least one locking divot and the at least one first protrusion being engaged with each other.
